(19) United States
(12) Patent Application Publication
(10) Pub. No.: US 2004/0041119 A1
(43) Pub. Date: Mar. 4, 2004

(54) Pressure-regulating valve

(76) Inventors: Markus Christen, Bochum (DE); Dietmar Uhlenbrock, Tecklenburg (DE)

Correspondence Address: STRIKER, STRIKER & STENBY, 103 East Neck Road, Huntington, NY, 11743, US

(21) Appl. No.: 10/436,669

(22) Filed: May 13, 2003

(30) Foreign Application Priority Data
Aug. 28, 2002 (DE) 102 39 407.5

(51) Int. Cl. F16K 1/00; F16K 15/00

(52) U.S. Cl. 251/331

(57) ABSTRACT

Known pressure-regulating valves, in particular, from the crank housing exhaust, have a regulating membrane made from an elastomer or a plastic. Elastomers, however, have a high permeability for hydrocarbons, an unsatisfactory chemical durability relative to oil, fuel and fuel additives and poor elasticity with low temperatures. Thermoplasts do not have these disadvantages and are better suited as materials for a regulating membrane. According to the present invention, it is proposed to use a membrane made from metal, preferably stainless steel. The membrane has a corrugated or graduated form. The pressure-regulating valve of the present invention has good characteristics with reference to permeability for hydrocarbons, chemical durability and temperature dependence of the elasticity and is substantially simplified through functional integration. The membrane assumes additionally the functions of a restoring spring and a housing cover.

### BACKGROUND OF THE INVENTION

The present invention relates to a pressure-regulating valve.

From DE 195 01 447 A1, a pressure-regulating valve for a crank housing exhaust is known. This pressure-regulating valve has a closure body that can be actuated by a regulating membrane. As the material for the regulating membrane, typically elastomers, for example, fluosilicon, are used, which, however, have disadvantages. Fluosilicon is expensive in machining and as a raw material and in addition, has a high permeability for hydrocarbons, which is problematic in view of statutory regulations relating to hydrocarbon emissions. In addition, fluosilicon has only a limited chemical durability relative to oil, fuel, fuel additives, acids, and formaldehydes. The elastomer ECO is move advantageous than fluosilicon, however, may no longer be used in the future.

It is also disadvantageous that the elasticity or deformability of the elastomer is greatly decreased with the minus temperatures of winter and, thereby, the function of the pressure-regulating valve is greatly impaired.

In the non-published German patent application with the reference number 10201823.5, a pressure-regulating valve with a thermoplastic membrane is proposed. With a thermoplastic membrane, the omission of a separate spring for biasing of the membrane is possible. The function of the spring can be integrated into the membrane; a spring action of the thermoplastic membrane, however, is comparatively greatly dependent on temperature.

### SUMMARY OF THE INVENTION

The pressure-regulating valve of the present invention, in contrast, has the advantage that in a simple manner, an improvement of the qualities compared with known pressure-regulating valves for adjusting the negative pressure in a crank housing of a motor vehicle is achieved, in which a metallic membrane is used. In the metallic membrane, a temperature-independent spring action for opening of the pressure-regulating valve is integrated, so that no separate spring is required. The metallic membrane assumes also the function of a housing cover. This simplifies the construction and minimizes manufacturing costs. The metallic membrane also has a high ability for sealing relative to hydrocarbons and is substantially cheaper than the elastomer membrane.

It is very advantageous if the membrane is made of stainless steel, since stainless steel has a high chemical durability relative to oil, fuel, fuel additives, acids, and formaldehydes.

It is particularly advantageous if a closing wall is provided as the closing body, which is a part of the metallic membrane. In this manner, the closing body can be eliminated, so that the pressure-regulating valve can be further simplified and the manufacturing costs lowered.

It is also advantageous if the metallic membrane is corrugated with valleys and elevations or if the membrane is graduated, since in this manner, a high elasticity is achieved. In the membrane, only bending tensions occur, which can be absorbed well by the membrane. Damaging tensile strains on a clamping position are avoided, so that a high longevity of the membrane is permitted.

It is also advantageous when a seal is arranged on a valve seat, on which the closing wall rests in the closed state of the pressure-regulating valve. The seal cushions the closing wall upon closing of the pressure-regulating valve and seals it off.

Furthermore, it is advantageous to provide a seal on the closing wall that cooperates with the valve seat, since in this manner, the valve seat is simplified and only comprises a level valve seat wall. A seal-receiving groove can be eliminated.

### BRIEF DESCRIPTION OF THE DRAWINGS

Embodiments of the invention are shown in a simple manner in the drawings and are explained in greater detail in the following description.

FIG. 1 shows a view in a longitudinal section of the pressure-regulating valve with a corrugated membrane; and

FIG. 2 shows a view in a longitudinal section of the pressure-regulating valve with a graduated membrane.

### DETAILED DESCRIPTION OF THE PREFERRED EMBODIMENTS

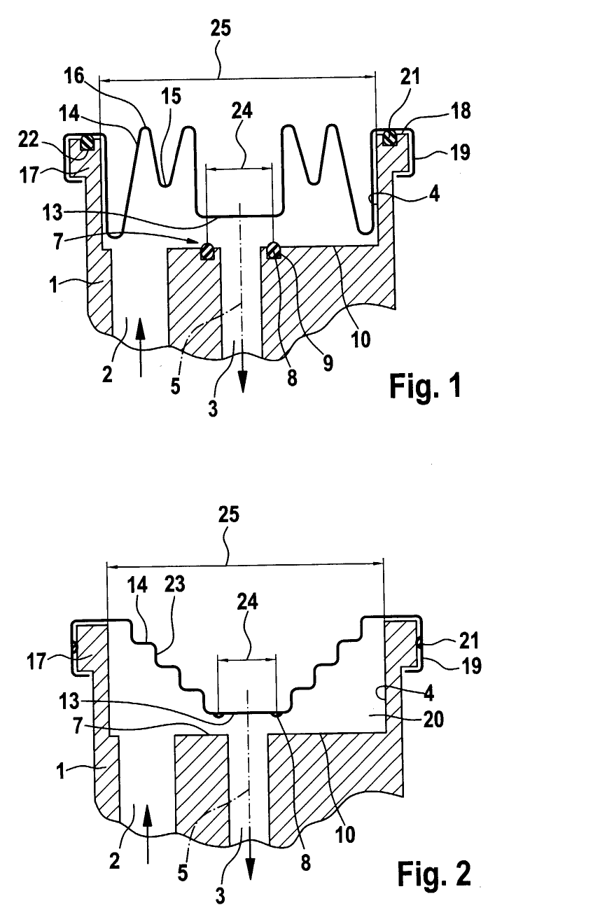

FIG. 1 shows a pressure-regulating valve according to the present invention with a corrugated membrane. The inventive pressure-regulating valve is preferably used in a crank housing exhaust or vent, in order to regulate a pressure in a crank housing to a predetermined, constant valve by means of the spring force of the metallic membrane. However, it is also possible to use the pressure-regulating valve in other areas for a pressure regulation.

During operation of an internal combustion engine, gas, based on a small leakage between pistons, piston rings, and cylinder running surface, flows from a combustion chamber into a crank housing. This gas is designated as blow-by gas. The term “gas” will be used for the term “blow-by gas” in the following description. By means of the leakage, a pressure increase occurs in the crank housing, so that it is necessary to achieve a pressure balance by means of a so-called crank housing exhaust or vent. Since the gas has a high hydrocarbon concentration, it is not possible that the gas can be released into the atmosphere. The crank housing exhaust therefore leads the gas via the inventive pressure-regulating valve into a suction rube of the internal combustion engine, so that from there, it can be supplied to combustion.

In the crank housing, by means of the gas flowing in at high speeds and by means of moving parts in the crank housing, an oil mist with many small and large oil particles exists. These oil particles must be separated by the crank housing exhaust with the assistance of an oil separator, in order to avoid a high oil loss.

The inventive pressure-regulating valve comprises a housing 1 with an inlet channel 2 that is at least directly connected with the crank housing and an outlet channel 3.

The cross section of the housing 1, the inlet channel 2, and the outlet channel 3 is round, for example. However, it is also possible that the cross section of the housing and/or the inlet channel 2 and/or the outlet channel 3 can be square, polygonal, or oval. The inlet channel 2 and the outlet channel 3 are connected with a recess 4 of the housing 1. The outlet channel 3 and the recess 4, for example, are centrally disposed on an axis 5 of the housing 1. The inlet channel 2 is provided radially outward from the axis 5. On an end of the outlet channel 3 facing the recess 4, a valve seat 7 is provided, in which, for example, an annular seal 8 is arranged. The seal 8, for example, is an O-ring. The seal 8 can also be eliminated, when an absolute seal on the valve seat 7 is not desired. The seal 8 is arranged in a sealing groove 9, which is formed in a valve seat wall 10. The valve seat 7 cooperates with a moveable, flat closing body wall 13, which, for example, is a part of a membrane. If the closing body wall rests on the valve seat 7, the connection, via the recess 4, between the input channel 2 and the output channel 3 is broken and the pressure-regulating valve is closed. If the closing body wall 13 does not rest on the valve seat 7, the pressure-regulating valve is opened. The closing body wall 13 is arranged in the recess 4 without an outer force action with spacing to the valve seat 7 between the valve seat wall 10 and a housing side 18. The membrane 14 is made from metal, for example, stainless steel. The membrane is corrugated with valleys 15 and projections 16. In this manner, a good elastic deformability, and therewith, a good spring action is achieved. In addition, only bending tensions occur in the material of the membrane 14, which can be easily absorbed by the thin-walled membrane 14. The corrugated form begins on the flat closing body wall 13, which, for example, is round in cross section, and extends radially outward. The membrane 14 closes off the recess 4 relative to the surroundings and is attached to the housing 1, for example, by a flanging 19 on a shoulder 17 near the housing side 18 of the housing 1. In this manner, the membrane 14 also assumes the function of a housing cover of the housing 1. The membrane 14, however, also can be attached to the housing by means of adhesive, welding, or clamping. On the shoulder 17, a second seal 21 is provided for sealing off the housing 1 from the surroundings. The seal 21, for example, is a sealing ring arranged in a second sealing groove 22. The second sealing groove 22 is arranged in the shoulder 17 on the housing side 18 facing the recess 4.

With the pressure-regulating valve of FIG. 2, like parts or similarly operating parts as those of FIG. 1 are designated with the same reference numerals. The pressure-regulating valve according to FIG. 2 differs from the pressure-regulating valve of FIG. 2 in that the metallic membrane is graduated with steps 23 and the seal 8 is not provided on the valve seat 7, rather on the closing body wall 13 of the membrane 14. The seal 8, for example, is vulcanized or adhered. The seal 8 can be eliminated, if no absolute seal on the valve seat 7 is desired.

The graduated form of the membrane 14 begins also on the closing body wall 13 and extends radially outward, whereby the steps 23 are arranged to be inclined radially outward from the closing body wall 13 in the direction of the housing side 18. By means of the graduated form, a good elastic deformability and therewith, a good spring action is also achieved.

On the shoulder 17, a second seal 21 for sealing the housing 1 from the surroundings is provided. The seal 21, for example, is vulcanized or adhered to the membrane on a periphery of the shoulder 17 on an inner side of the membrane 14 facing the housing 1. For sealing off the housing 1, as in FIG. 1, a sealing ring in the second sealing groove 22 is also possible.

Since the pressure in the suction tube of the internal combustion engine sharply fluctuates and the crank housing is connected with the suction tube upon ventilation, the pressure fluctuations are expanded until in the crank housing. The pressure-regulating valve avoids this.

With an opened pressure-regulating valve, a inner chamber-pressure, which is predetermined from the pressure in the suction tube and the pressure in the crank housing, in an inner chamber 20 surrounded by the membrane 14 and the recess 4 is adjusted. The inner chamber-pressure is a negative pressure and acts on a large surface 25 of the membrane 14.

With a closed pressure-regulating valve, only the inner chamber-pressure is adjusted, which is predetermined from the pressure in the crank housing, which is a very small negative pressure and acts on the large surface 25, less a small surface 24, of the membrane 14. The prevailing negative or low pressure in the suction tube acts on the small surface 24.

An equilibrium of forces is adjusted on the membrane 14, on which a spring force of the membrane 14, determined by the shape and thickness of the membrane, and a force resulting from the pressure difference of the inner chamber-pressure and surrounding pressure, are involved. With a closed pressure-regulating valve, additionally a suction force is involved, which results in the negative or low pressure prevailing in the suction tube and acting on the small surface 24.

Depending on the equilibrium of forces, the pressure-regulating valve opens or closes.

As soon as the closing body wall 13 lies on the vale seat 7, only a negative or low pressure acts on the small surface 24. The spring force of the membrane 14 is laid out such that the pressure-regulating valve now is again open, so that again, a negative or low pressure acts on the large surface 25. It adjusts an equilibrium, in which the closing body wall 13 has a constant distance to the valve seat wall 10.

The spring force of the membrane 14 is configured such that the pressure-regulating valve is then closed in a safety position, when the negative or low pressure in the suction tube exceeds a predetermined value. This then prevents the crank housing from being suctioned empty by means of a high negative pressure.

By the construction of the spring force of the membrane 14, the pressure can be determined, which is adjusted in the crank housing.

The smaller the distance between the closing body wall 13 and the valve seat wall 10 is, the smaller the volume flow of the blow-by gas in the suction tube is.

It will be understood that each of the elements described above, or two or more together, may also find a useful application in other types of constructions differing from the types described above.

While the invention has been illustrated and described herein as a pressure-regulating valve, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. Pressure-regulating valve for adjustment of a negative pressure in a crank housing of a motor vehicle, comprising a housing, in which a valve seat is arranged and a closing wall is movably supported by means of a membrane, characterized in that the membrane (14) is made of metal.

2. Pressure-regulating valve according to claim 1, characterized in that the membrane (14) is made of stainless steel.

3. Pressure-regulating valve according to claim 1, characterized in that the membrane (14) is corrugated.

4. Pressure-regulating valve according to claim 1, characterized in that the membrane (14) is graduated.

5. Pressure-regulating valve according to claim 1, characterized in that the membrane (14) is provided as a housing cover.

6. Pressure-regulating valve according to claim 1, characterized in that the seal (8) is arranged on the membrane (14).

7. Pressure-regulating valve according to claim 1, characterized in that the valve seat (7) has a seal (8).

8. Pressure-regulating valve according to claim 1, characterized in that the closing wall (13) is connected as one-piece with the membrane (14).
